(19) United States
(12) Patent Application Publication
(10) Pub. No.: US 2003/0204403 A1
(43) Pub. Date: Oct. 30, 2003

(54) Memory module with voice recognition system

(76) Inventor: James Vernard Browning, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/132,052

(22) Filed: Apr. 25, 2002

(51) Int. Cl. G10L 21/00

(52) U.S. Cl. 704/270

(57) ABSTRACT

A memory module compatible for use with a host electronic device. The memory module includes an adapter region for interfacing the memory module with the host electronic device, a memory component and an on-card intelligent controller. A voice recognition system is provided in communication with the on-card intelligent controller to translate audio data into executable file management commands.

### THE FIELD OF THE INVENTION

The present invention generally relates to memory modules, and more particularly, to a memory module having a voice recognition system.

### BACKGROUND OF THE INVENTION

The need for portability and ease in capturing and saving information from various locations away from a user's office or work has resulted in a proliferation of portable electronic devices, such as digital cameras, personal digital assistants, and notebook computers. With the proliferation of portable electronic devices, the use of form factor cards adapted for use with these devices is steadily increasing as well. The term “form factor card” is a general term often used to describe a memory card, such as a SONY memory stick or CompactFlash card, but also applies to cards that perform other functions, including I/O cards such as serial cards, Ethernet cards, fax/modem cards, wireless pagers, and multimedia cards.

Although such portable electronic devices are small, reducing their size to be even smaller and more portable is desirable. Further reductions in size, however, are limited by the current physical user interface requirements. Due to the physical space occupied by user input buttons, the output display on such capture devices is often quite small by necessity, making use of the display less functional than desired. Consequently, the use of user interface tools such as a keyboard or virtual keyboard that require a display also becomes problematic. What is needed is an efficient system that allows the user to interact with such portable electronic devices to manage files that is not keyboard dependent or dependent on the size of a portable electronic device and does not increase the cost of the portable electronic device.

### SUMMARY OF THE INVENTION

The present invention provides a memory module compatible for use with a host electronic device. In one embodiment, the memory module includes an adapter region for interfacing the memory module with the host electronic device, a memory card component and an on-card intelligent controller. A voice recognition system is provided in communication with the on-card intelligent controller to translate audio data into an executable file management command.

### BRIEF DESCRIPTION OF THE DRAWINGS

FIG. 1 is a diagram illustrating one exemplary embodiment of a host electronic device having a memory card according to the present invention.

FIG. 2 is a block diagram illustrating one exemplary embodiment of a host electronic device having a memory card according to the present invention.

FIG. 3 is a block diagram illustrating another exemplary embodiment of a memory card according to the present invention positioned within a host electronic device.

FIG. 4 is a diagram illustrating one exemplary embodiment of a display showing communication between a user and a host electronic device having a memory card according to the present invention.

FIG. 5 is a diagram illustrating one embodiment of a display showing a file management options menu for use with a file management system according to the present invention.

FIG. 6 is a diagram illustrating one exemplary embodiment of a display showing an image editing options menu for use with a file management system according to the present invention.

FIG. 7 is a diagram illustrating one exemplary embodiment of a memory card according to the present invention for use with a digital camera.

FIG. 8 is a diagram illustrating one exemplary embodiment of a display showing a file management system according to the present invention for use with a digital camera.

FIG. 9 is a flow diagram illustrating one exemplary embodiment of a method of managing a file according to the present invention.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

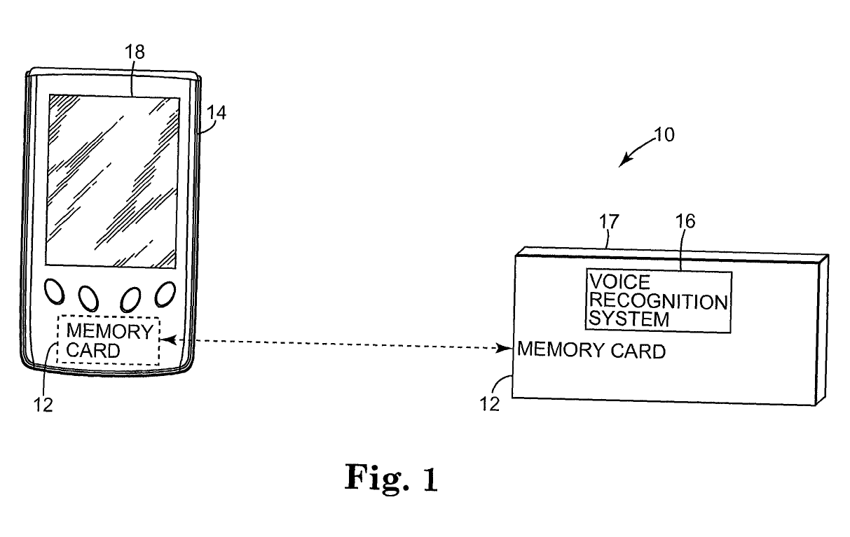

FIG. 1 is a block diagram illustrating one exemplary embodiment of a file management system 10 according to the present invention. File management system 10 includes a memory module 12 and a host electronic device 14. In one embodiment, memory module 12 is termed a “memory card.” Host electronic device 14 can be any device utilizing a memory card including, but not limited to, digital cameras, digital camcorders, personal digital assistants, laptops, and notebook computers or other mobile computing devices. In one embodiment, host electronic device 14 is a personal digital assistant or “PDA” as is known in the art. Before installation of memory card 12, host electronic device 14 is unable to receive and execute voice input commands or audio data (e.g., spoken voice commands). However, when memory module 12 is installed or “plugged into” host electronic device 14, a user is then able to access menu functions of host electronic device 14 via the voice input commands. In one embodiment, memory card 12 includes a voice recognition system 16. Voice recognition system 16 is located on memory card 12 and used to enable host electronic device 14 to interact with the user via the input of audio data. Once memory module 12 is installed or plugged into host electronic device 14, host electronic device 14 is ready to receive the audio data and interact with the user via the user's spoken voice commands to manage a file.

In one embodiment, host electronic device 14 includes a display 18. When host electronic device 14 receives the voice input command from the user, the voice input command associated with an executable file management command via voice recognition system 16 of memory card 12. Upon receiving an output signal from memory card 12, host electronic device 14 outputs a menu to display 18 of host electronic device 14. The user can then choose the executable file management command from display 18 by simply stating a choice off of the menu output to display 18. For example, the user can issue a voice command to “save,” “cut,” “copy,” “paste,” or “delete” to edit or manage a file. Once host electronic device 14 recognizes the voice input command or audio input as the executable file management command, host electronic device 14 performs the desired file management operation. In one embodiment, if memory card 12 receives audio data that cannot be associated with the executable file management command, an indication of no match, such as an audible word or beep pattern, is output to the user. Memory card 12 then waits to receive the next voice input command or audio data. Thus, the user is able to interact with host electronic device 14 without the need for traditional physical user interface requirements such as a keyboard or stylus for use with a virtual keyboard as are known in the art. The unique system for managing a file via the voice input command according to the present invention is described in detail in this application.

In one embodiment, the voice input command allows the means for a memory card 12 to be both “keyed” to a particular user through the use of a spoken password. If memory card 12 is removed from host electronic device 14 and installed into another host electronic device, it will not function until a proper password is received and processed. This would prevent anyone other than the user from accessing information stored on memory card 12 by removing memory card 12 from host electronic device 14 and reinstalling memory card 12 in another host electronic device to access the information stored on memory card 12. Thus, information security of memory card 12 is independent of host electronic device 14.

In one embodiment, memory card 12 can be trained to recognize the user's spoken voice control input commands through voice analysis software. In one embodiment, voice recognition system 16 includes the voice analysis software. In another embodiment, the voice analysis software is located in a host computer system. When memory card 12 is installed and engaged by host electronic device 14, the host computer system is used to train memory card 12 to recognize the user's spoken voice. In either embodiment, for example, the user will be given a predetermined list of the functions that can be executed by host electronic device 14 with the audio data input. Command 1, for example, may represent a function saving the file in a particular directory. In selecting command 1 for training and analysis, the user will be prompted by the voice analysis software to choose a word that the user wants to use to invoke the set of instructions for saving the file. The user would then be prompted to repeat the chosen word a number of times. A logical choice would be to use the word “save,” but any word chosen by the user could be used. Each repetition of the word “save” is picked up by memory card 12 and analyzed by the voice analysis software to develop a recognition pattern to encompass the variations and inflections in the user's voice in issuing the “save” voice input command. The recognition patterns for all the words chosen by the user to invoke the various functions are stored in a static memory on memory card 12 in a command recognition table. The recognition patterns and the command recognition table are each linked to the predetermined sets of instructions for the various functions, which are also stored in the static memory of memory card 12. Thus, when the voice input command is received and recognized by memory card 12, the set of instructions associated with that command word are transferred to host controller 34 of host electronic device 14. Host electronic device 14 then executes the executable file management commands. In this embodiment, foreign languages can be used for the voice input command which can then be translated to the executable file management command. Since the set of instructions for a function are tied to the user's word choice and subsequent training in voice analysis of that word choice.

In another embodiment, there is no word choice given the user for training in voice analysis. The recognition patterns in the command recognition table are predetermined and tied to specific words the user must use via a list of predefined words. Thus, the user would have to modify his or her pronunciation of the command word “save,” for example, until host electronic device 14 via memory card 12 recognizes the command as spoken by the user. Memory card 12 would be primarily directed to a particular language where the command words were indicative of the resulting actions. Foreign language versions of the device would be made for users utilizing foreign words indicative of the resulting actions.

In one embodiment, file management system 10 can be implemented in hardware via a microprocessor, programmable logic device or state machine, in firmware, or in software. Other programming languages and communication bus protocols suitable for use with the file management system according to the present invention will become apparent to those skilled in the art after reading the present application.

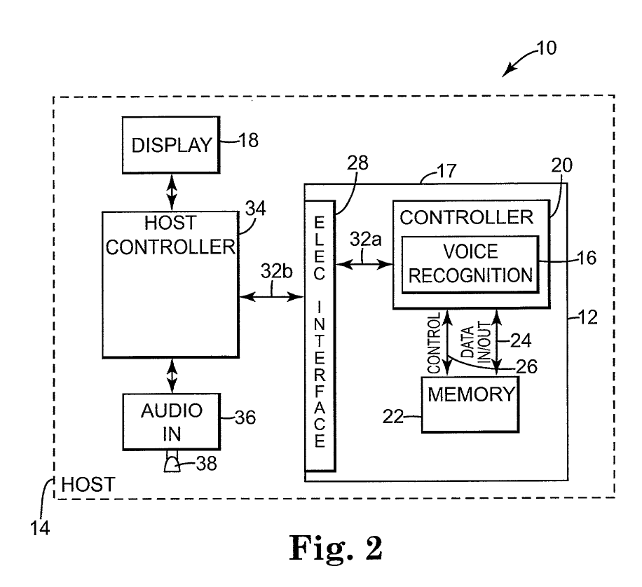

FIG. 2 is a block diagram illustrating one exemplary embodiment of memory card 12 according to the present invention installed within host electronic device 14. In one embodiment, memory module 12 is a form factor card, as is known in the art, which is installed and engaged by host electronic device 14. In one embodiment, memory card 12 includes voice recognition system 16, an on-card intelligent controller 20, a memory 22, data channels 24, control channels 26 and an electrical interface 28 for connection to host electronic device 14, and housing 17. In one embodiment, memory card 12 is a CompactFlash storage card meeting the CFt and CompactFlash Specification of the CompactFlash Association (www.compactflash.org). The CFt and CompactFlash Specification is herein incorporated by reference. On-card intelligent controller 20 receives the audio data from host electronic device 14 and translates the audio data into executable file management commands via voice recognition system 16. On-card intelligent controller 20 communicates with host electronic device 14 via electrical interface 28 and interface channels 32a and 32b. On-card intelligent controller 20 also manages interface protocols with host electronic device 14, data storage and retrieval, diagnostics, defect handling, error correcting, and power management and clock control functions. In one embodiment, on-card intelligent controller 20 is a microprocessor. In one embodiment, memory 22 is preferably non-volatile memory. Suitable nonvolatile memory includes, but is not limited to, flash memory and magnetic random access memory (MRAM), or other persistent storage device such as a micro disk drive.

In one embodiment, Interface channels 32b transfer data between host electronic device 14 and memory card 12. In the installed position, as illustrated in FIG. 1, host interface channels 32b are engaged with electrical interface 28. Host interface channels (i.e., bus) 32b transfer data between host electronic device 14 and memory card 12 and provide electrical power to memory card 12 via electrical interface 24 and interface channels 32a. In one embodiment, on-card intelligent controller 20 controls the on/off status of voice recognition system 16.

In one embodiment, on-card intelligent controller 20 includes voice recognition system 16. Voice recognition system 16 includes voice analysis software 26 as is known in the art. On-card intelligent controller 20 interacts with host electronic device 14 to receive the audio data from host electronic device 14 via electrical interface 28. On-card intelligent controller 20 then interacts with memory 22 to translate the audio data into the executable file management command and send an signal with the executable file management command to host electronic device 14 via electrical interface 28.

In one embodiment, electrical interface 28 comprises an array of female connectors, but can take the form of a plurality of embodiments, including but not limited to an array of male pin-connectors.

In one embodiment, host electronic device 14 includes display 18, a host controller 34, and an audio input system 36 having an audio microphone 38. Audio input system 36 is controlled by host controller 34. The audio data is input to host controller 34 via audio input system 36 at audio microphone 38. Audio input system 36 interacts with host controller 34 to transfer the audio data to host controller 34. Once the audio data is input to host controller 34, host controller 34 transfers the audio data to memory card 12 via on-card intelligent controller 20 for association of the audio data or voice input command with the executable file management command. Upon receiving the audio data from host controller 34, on-card intelligent controller 20 saves the audio data in memory 22 of memory card 12. The on-card intelligent controller 20 then processes the audio data and compares a recognition pattern for the audio data with a recognition pattern stored in the command recognition table held in a static memory of memory 22. When a match is found, execution of a set of instructions tied to the recognition pattern begins. On-card intelligent controller 20 transfers the executable file management commands to host electronic device 14 via host controller 34. Host controller 34 then executes the executable file management commands and/or displays additional menu functions for the user to choose.

In one embodiment, the set of instructions for a particular executable file management command may include acknowledging the executable file management command back to the user by outputting an audible beep, audible playback of the command name, or illuminating a light emitting diode (LED) as is known in the art. In one embodiment, particular commands may also have one or more time delays built into the set of instructions to allow time for the user to physically manipulate host electronic device 14 or to cancel the executable file management command. If the user wishes to change the executable file management command just issued, or if host electronic device 14 via memory card 12 interpreted the executable file management command incorrectly, the user can cancel the executable file management command before it is executed through a cancel or clear button on host electronic device 14 or through a voice command that cancels the executable file management command received. Otherwise, if no audio input is received to cancel the executable file management command, the set of instructions for the executable file management command are executed by host controller 34. Thus, when memory module 12 is installed or plugged into host electronic device 14, the user is able to interact with host electronic device 14 via the voice command to navigate through menu functions and manage files without any additional physical user interface requirements.

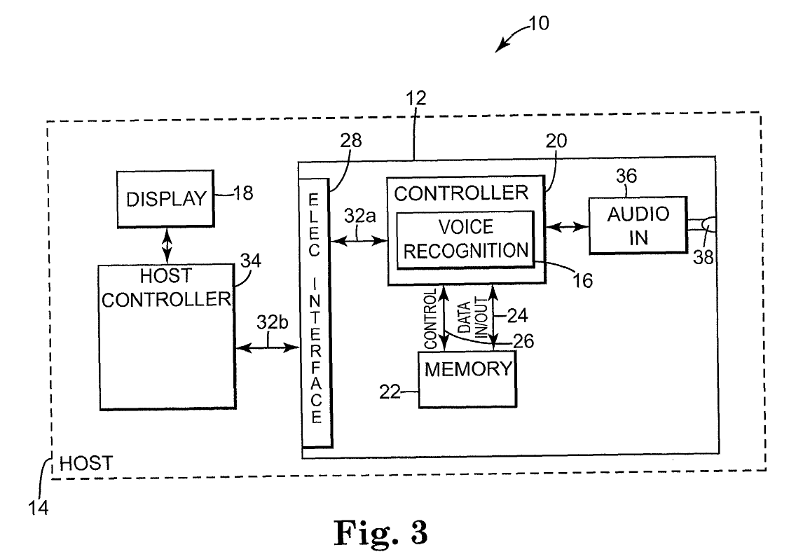

FIG. 3 is a block diagram illustrating another exemplary embodiment of file management system 10 according to the present invention. In one embodiment, memory module 12 includes voice recognition system 16. Voice recognition system 16 includes voice analysis software 26 and audio input system 36 having audio microphone 38. The audio data for navigating through menu functions and managing files is given by the user speaking in close enough proximity to be picked up by audio microphone 38. Audio microphone 38 converts the user's speech or audio data into an analog signal, which is provided to audio input system 36. In one embodiment, audio input system 36 includes an analog-to-digital converter, which converts the analog signal generated by audio microphone 38 into a digital signal. The digital signal is then sent by audio input system 36 to on-card intelligent controller 20, which saves the digital signal in memory 22. In one embodiment, memory 22 includes both dynamic memory, and the static memory. On-card intelligent controller 20 interacts with memory 22 via voice analysis software 26 stored in the static memory of memory 22 to perform a series of frequency domain transforms on the digital signal stored in the dynamic memory of memory 22. In one embodiment, voice analysis software 26 generates a recognition pattern, which is a spectral transform, that is compared to recognition patterns (also spectral transforms) for the executable file management command stored in the static memory of the memory 22. Suitable voice analysis software for use with the present invention are disclosed in U.S. Pat. No. 6,289,140 B1 to Oliver for “Voice Control Input for Portable Captured Devices” issued Sep. 11, 2001, to the assignee in common with the present invention, which is incorporated herein by reference. One skilled in the art will recognize that other suitable method for recognizing voice patterns could be used in the present invention instead of spectral transforms after reading the present application. When memory card 12 is installed or plugged into host electronic device 14, host electronic device 14 is enabled to interact with the user via the voice input command or audio data in the form of verbal commands. The user is then able to navigate the menu functions of host electronic device 14 to manage files even though host electronic device 14 is not itself equipped with voice recognition system 16. Thus, the only requirement for the user to be able to navigate menu functions and manage files via the voice input command is that host electronic device 14 is able to interact with memory module 12.

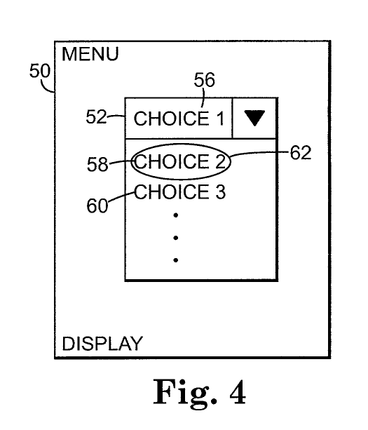

FIG. 4 is a diagram illustrating one exemplary embodiment of display 18 showing communication between the user and host electronic device 14 having memory card 12. In one embodiment, display 18 includes a drop down menu 50 as is known in the art. Drop down menu 50 has an associated dropdown list 52 that is output to display 18 in response to the executable file management commands received by host controller 34 from on-card intelligent controller 20 of memory card 12. In one embodiment, drop-down list 52 contains multiple individually selectable choices 56, 58 and 60 that are each indicated by a textual or graphical choice label 62. Each of choices 56, 58 and 60 in drop-down list 52 is preferably displayed with a graphical indication of whether or not that choice is currently selected. In one embodiment, such graphical indication may involve highlighting selected choices or displaying a graphical element, such as a radio button or another mark (e.g., check mark) in conjunction with at least one of the selected choices.

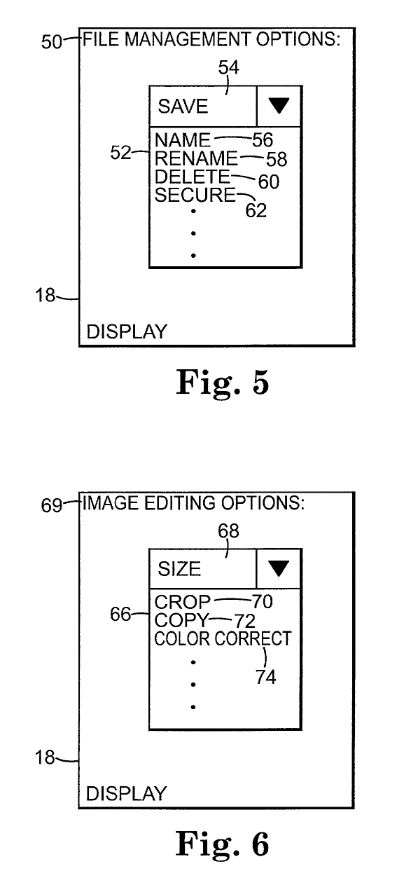

FIG. 5 is a block diagram illustrating one exemplary embodiment of a file management options menu 50 for use with file management system 10 according to the present invention. In one embodiment, the user interacts with host electronic device 14 to manage the file via file management options menu 50, which are output to display 18 of host electronic device 14 when a corresponding executable file management command is received by host controller 34. File management options menu 50 may include a plurality of executable file management commands 52. In one embodiment, plurality of executable file management commands 52 includes a save command 54, a name command 56, a rename command 58, a delete command 60, and a secure command 62, which allow the user to efficiently navigate file management options by choosing an appropriate command from display 18. For example, the user may request file management options menu 50 by simply saying “file.” The audio input “file” is translated into an executable command via memory card 12. Memory card 12 then directs host controller 34 to display file management options 50 on display 18 of host electronic device 14 by transferring the executable file management command corresponding to the audio input “file.” The user can then choose file management command 52 by simply reading a command off of display 18.

FIG. 6 is a block diagram illustrating one exemplary embodiment of an image editing options menu 64 for use with file management system 10 according to the present invention. In one embodiment, the user interacts with host electronic device 14 to edit an image captured and/or stored by host electronic device 14 via image editing options menu 64. Image editing options 64 may include a plurality of executable image editing commands 66. In one embodiment, plurality of executable image editing commands 66 includes a size command 68, a crop command 70, a copy command 72, and a color correct command 74, which allow the user to edit the image captured and/or stored by host electronic device 14. For example, the user may request image editing options menu 64 by saying “image.” The audio input “image” is translated into plurality of executable image editing commands 66 executable via memory card 12. Memory card 12 then directs host controller 34 to display image editing options menu 64 on display 18 of host electronic device 14. The user can then again choose plurality of executable image editing commands 66 by reading a command off of display 18.

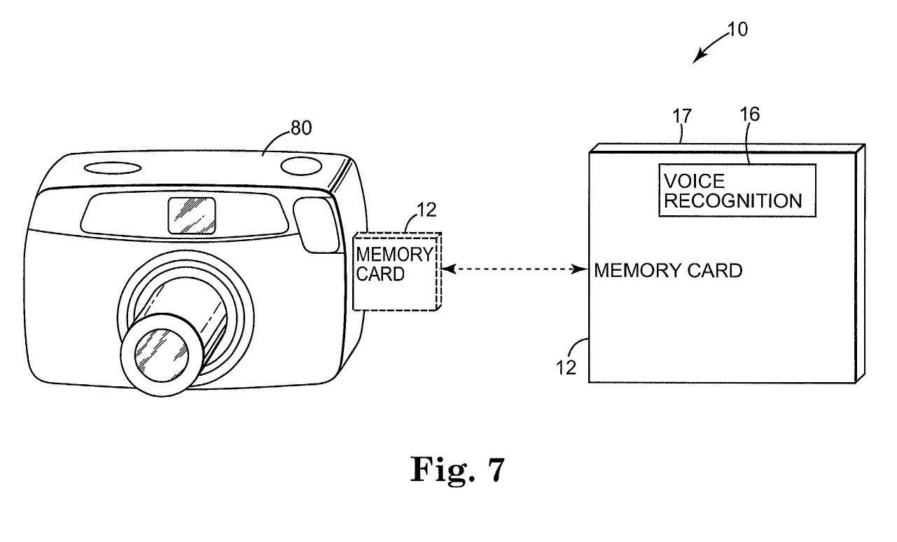

FIG. 7 is a block diagram illustrating an exemplary embodiment of a digital camera 80 having a memory card according to the present invention. Due to the physical space occupied by user input buttons, a display in such devices is often quite small by necessity, making use of the display less functional. Thus, file management system 10 is especially useful in such devices. In one embodiment, memory card 12 is installed or “plugged into” digital camera 80 to enable digital camera 80 to interact with the user via the audio data. The user can then access menu functions of digital camera 80 by speaking a desired predetermined command, which is translated into the executable file management command needed by digital camera 80 by memory card 12. Memory card 12 includes a voice recognition system 16 and a housing 17. In one aspect, the user interacts with digital camera 80 via voice recognition system 16, which is located on memory card 12. Once memory card 12 is installed or plugged into digital camera 80, the user is able to interact with digital camera 80 via audio data to manage image files without the need for physical user interface requirement.

Additional file management options and image editing options, as are known in the art, may be represented by additional subfields of plurality of file management commands 50 and plurality of image editing commands 66.

It is to be understood that FIGS. 5-7 are simplified illustrations of exemplary embodiments of display 18. The illustrative presentation of the options menus and commands including respective subfields, for example, has been simplified for clarity of the invention. The subfields may be presented, for example, as open fields, pull-down menus, toggle selections, and/or highlighted or framed selections. In addition, display 18 may be presented, for example, in one or more screens or views. It is understood that such alternatives are within the scope of the present invention.

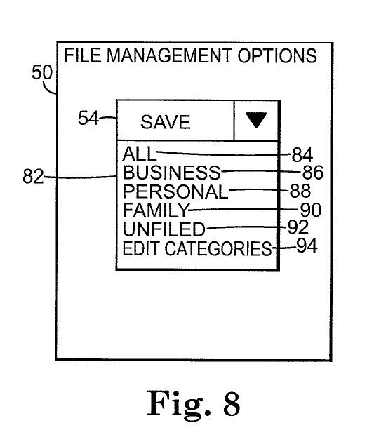

FIG. 8 is a diagram illustrating one exemplary embodiment of display 18 showing file management system 10 for use with digital camera 80. In one embodiment, save command 54 of file management options 50 allows the user to group an image captured by digital camera 80 into a plurality of categories 82. In one embodiment, plurality of categories 82 includes, for example, choices for all 84, business 86, personal 88, family 90, and unfiled 92. The user is able to choose in which predefined category the image should be filed by simply speaking an appropriate command associated with the predefined category. In another embodiment, the user is able to define a category by choosing edit categories 94 to group the image into a user-defined category.

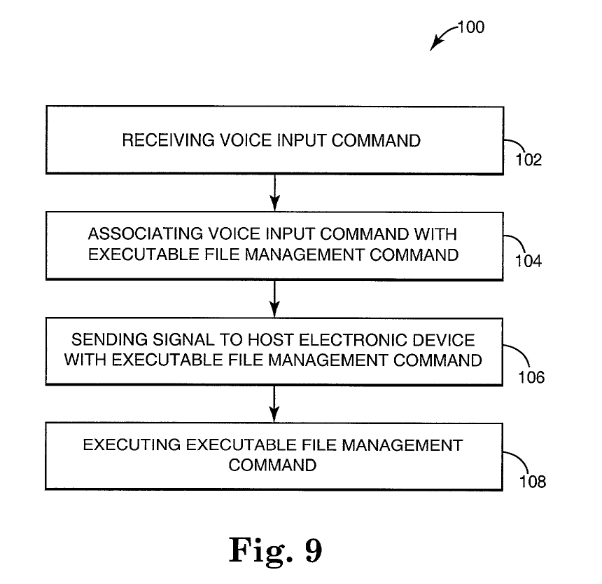

FIG. 9 is a flow diagram illustrating an exemplary embodiment of a method of managing a file via a voice input command. The method of managing a file via the voice input command according to the present invention is illustrated generally at 100. Reference is also made to FIGS. 1-7. At 102, memory card 12 having a voice recognition system is interfaced with host electronic device 14. At 104, host electronic device 14 receives the voice input command or audio data. In one embodiment, host electronic device 14 includes audio input system 36 having audio microphone 38. In another embodiment, audio input system 36 having audio microphone 38 is located on memory card 12. At, 106, the voice input command is associated with the executable file management commands that are stored in memory 22 via on-card intelligent controller 20. At 108, once the voice input commands are identified and associated with the executable file management commands stored in memory 22, on card-intelligent controller 20 sends a signal to host electronic device 14 with the executable file management command. In one embodiment, the executable file management commands are displayed on display 18 of host electronic device 14. At 110, host electronic device 14 executes the executable file management commands, thereby allowing the user to manage files via a voice input command without the need for additional physical user interface requirements.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A memory module compatible for use with a host electronic device, the memory module comprising:
an adapter region for interfacing the memory module with the host electronic device;
a memory component;
an on-card intelligent controller; and
a voice recognition system in communication with the on-card intelligent controller configured to translate audio data into an executable file management command.

2. The memory module of claim 1, wherein the voice recognition system includes at least one of an audio input system and voice analysis software.

3. The memory module of claim 2, wherein the audio input system includes an audio microphone and an analog-digital converter.

4. The memory module of claim 1, wherein the memory component further comprises a dynamic memory and a static memory.

5. The memory module of claim 1, wherein in response to the executable file management command, an output signal is provided to the host electronic device via the on-card intelligent controller.

6. The memory module of claim 1, wherein in response to the executable file management command, data is received from the host electronic device and stored in the memory component.

7. The memory module of claim 6, the memory component including a plurality of predefined memory locations, wherein in response to the executable file management command, data is stored in one of the plurality of predefined memory locations.

8. The memory module of claim 1, wherein the voice recognition system has an on and off status controlled by the on-card intelligent controller.

9. The memory module of claim 1, the audio data including a voice command, wherein the memory module enables the host electronic device to interact with a user via the audio data when the user issues the voice command.

10. The memory module of claim 9, wherein the memory module including a voice recognition component, wherein the voice recognition component is used to train the memory module.

11. The memory module of claim 9, wherein the voice command is a predetermined voice command.

12. The memory module of claim 11, wherein the predetermined voice command is selected from a display of the host electronic device.

13. The memory module of claim 11, wherein the predetermined voice command is stored in the memory component.

14. The memory module of claim 1, wherein the memory module is a removable memory, and wherein the on-card intelligent controller controls access to information stored on the removable memory.

15. The memory card of claim 14, wherein the on-card intelligent controller prevents unauthorized access to the removable memory.

16. A memory card having a voice recognition system for generating a predetermined voice command menu for use by a host electronic device.

17. The memory card of claim 16, wherein the predetermined voice command menu includes a list of predefined words a user must use to manage a file.

18. The memory card of claim 16, wherein the memory card includes an on-card intelligent controller and wherein the predetermined voice command menu is generated by the on-card intelligent controller.

19. The memory card of claim 16, wherein the predetermined voice command menu includes file management options.

20. The memory card of claim 19, wherein the file management options include a plurality of file management commands.

21. The memory card of claim 16, wherein the predetermined voice command menu includes image editing options.

22. The memory card of claim 21, wherein the image editing options include a plurality of image editing commands.

23. A method of managing a file via a memory card, the method comprising:
receiving a voice input command;
associating the voice input command with an executable file management command;
sending a signal to a host electronic device with the executable file management command; and
executing the executable file management command.

24. The method of claim 23, wherein executing the executable file management command includes storing data on the memory card.

25. The method of claim 23, wherein executing the executable file management command includes defining the memory card to include an on-card intelligent controller that translates the voice input command into the executable file management command by comparing the voice input command with the data stored on the memory card.

26. The method of claim 29, wherein executing the executable file management command includes grouping the data stored on the memory card.

27. The method of claim 23, wherein executing the executable file management command includes providing a display output to the host electronic device.

28. A mobile computing system, comprising:
a mobile computing device; and
a memory module in communication with the mobile computing device including an adapter region for interfacing the memory module with the mobile computing device; a memory component, an on-card intelligent controller, and a voice recognition system in communication with the on-card intelligent controller configured to translate audio data into an executable file management command.

29. The mobile computing system of claim 28, wherein the mobile computing device is a personal digital assistant.

30. A digital camera system, comprising:
a digital camera; and
a memory module in communication with the digital camera including an adapter region for interfacing the memory module with the mobile computing device; a memory component, an on-card intelligent controller, and a voice recognition system in communication with the on-card intelligent controller configured to translate audio data into an executable file management command.

31. A computer-readable medium having computer-executable instructions for performing a method of managing a file via a memory card, comprising:
receiving a voice input command;
associating the voice input command with an executable file management command;
sending a signal to a host electronic device with the executable file management command; and
executing the executable file management command.
